(19) United States
(12) Patent Application Publication
(10) Pub. No.: US 2015/0308373 A1
(43) Pub. Date: Oct. 29, 2015

(54) METHOD OF SCHEDULING PRESSURE IN VARIABLE PRESSURE ACTUATION SYSTEMS

(71) Applicant: Hamilton Sundstrand Corporation, Charlotte, NC (US)

(72) Inventor: Craig T. Stambaugh, SR., Tolland, CT (US)

(73) Assignee: Hamilton Sundstrand Corporation, Charlotte, NC (US)

(21) Appl. No.: 14/259,553

(22) Filed: Apr. 23, 2014

(51) Int. Cl. F02K 1/09

(52) U.S. Cl. CPC F02K 1/09; F05D 2270/051; F05D 2270/64

(57) ABSTRACT

In one aspect, a variable pressure actuation system is provided. The variable pressure actuation system includes an actuator configured to control a variable geometry device, and a fluid line fluidly coupled to the actuator. The fluid line is configured to supply a pressurized fluid to the actuator to facilitate controlling the variable geometry device. The system further includes a load feedback device coupled to the actuator, the load feedback device configured to measure a load placed on the actuator by the variable geometry device.

### BACKGROUND OF THE INVENTION

This disclosure generally relates to variable pressure actuation systems, and more particularly, to variable pressure actuation systems for aircraft and jet engines.

Modern aircraft are increasingly incorporating more electrically operated systems, which may increase heat generation within the aircraft. Managing this heat generation while maintaining weight, cost, and reliability goals has become an increased focus in production and design.

Some aircraft and/or the engines that power them may include variable pressure actuation systems, which have generated less waste heat than some previous systems. However, fluid supply pressure in the system is typically scheduled to levels by algorithms based on predicted load at the current operating condition. The prediction algorithms may need to account for the uncertainty of the load prediction, which can become significant due to system complexity and control surface being actuated. This may require the algorithms to operate conservatively when scheduling pressure, particularly when it is difficult to take system age and deterioration into account. Accordingly, some known variable pressure actuation systems may require pressure to be scheduled at a much higher level than is actually needed, thus requiring increased levels of pumping system horsepower, which results in higher heat generation.

### BRIEF DESCRIPTION OF THE INVENTION

In one aspect, a variable pressure actuation system is provided. The variable pressure actuation system includes an actuator configured to control a variable geometry device, and a fluid line fluidly coupled to the actuator. The fluid line is configured to supply a pressurized fluid to the actuator to facilitate controlling the variable geometry device. The system further includes a load feedback device coupled to the actuator, the load feedback device configured to measure a load placed on the actuator by the variable geometry device.

In another aspect, a method is provided for scheduling pressure in a variable pressure actuation system that has an actuator configured to control a variable geometry device, a fluid line fluidly coupled to the actuator, and a load feedback device coupled to the actuator. The method includes measuring, with the load feedback device, a load placed on the actuator by the variable geometry device, and scheduling a fluid pressure level in the fluid line based on the measured load.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an exemplary variable pressure actuation system; and

FIG. 2 is a schematic illustration of another exemplary variable pressure actuation system.

### DETAILED DESCRIPTION OF THE INVENTION

Described herein are systems and methods for scheduling fluid pressure levels in variable pressure actuation systems to reduce the heat generated thereby. The systems utilize actual load measurements to schedule the fluid pressure, rather than relying on prediction algorithms. Specifically, dynamic measurement of a load on an actuator and a measurement of the system load carrying capability are utilized to precisely and dynamically determine a pressure level required to counteract the load encountered on the actuator at a particular operating condition.

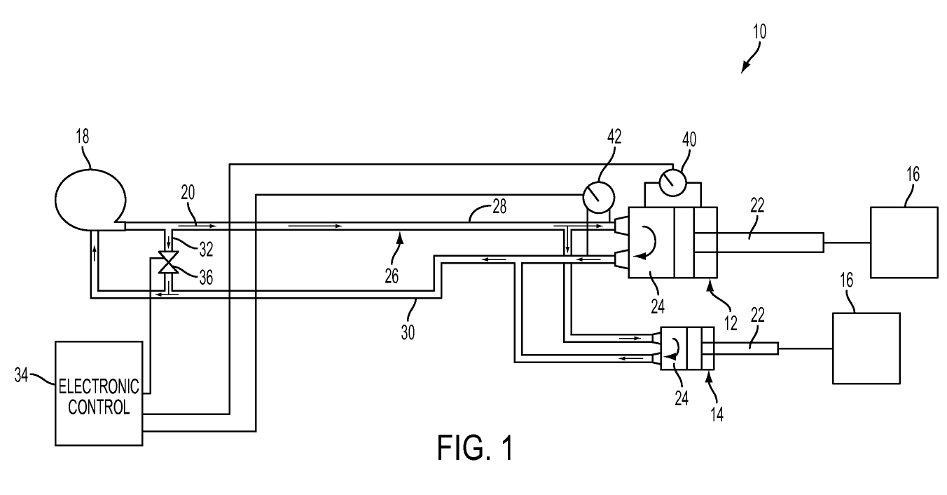

FIG. 1 illustrates an exemplary variable pressure actuation system 10 that provides pressurized fluid for actuation of a first actuator 12 and a second actuator 14 to control the operation of a variable geometry device 16. In one example, variable geometry device 16 may be a variable area exhaust nozzle of a jet engine (not shown), which modulates the engine thrust. A nozzle actuation system (not shown) may be used to adjust the exhaust nozzle area to either enlarge or reduce the area, as required by the engine operating conditions.

Actuation of the exhaust nozzles to adjust the nozzle area is generally accomplished by a variable displacement hydraulic pump 18 that provides a pressurized fluid 20 (e.g., engine fuel) to actuators 12, 14. However, pump 18 may be any suitable type of pump that enables system 10 to function as described herein. In the exemplary embodiment, actuators 12, 14 are piston-cylinder type actuators that include a piston 22 and a cylinder 24. However, actuators 12, 14 may be any suitable actuator that is actuated by a pressurized fluid. Moreover, although two actuators are illustrated, system 10 may have any number of actuators (e.g., one or four).

Variable pressure actuation system 10 includes a fluid line 26 fluidly coupled between pump 18 and actuators 12, 14. Fluid line 26 includes a supply pressure line 28, a return pressure line 30, and a bypass line 32. Fluid 20 is provided to pump 18 from a reservoir (not shown) and is subsequently supplied to actuators 12, 14 to translate piston 22. Fluid 20 within actuator cylinder 24 is then returned via line 30 to pump 18 or the reservoir for further use.

System 10 includes a controller 34 that is in signal communication with a pressure control device 36 within bypass line 32. Controller 34 is programmed to control or “schedule” a pressure level for fluid 20 to provide fluid 20 at a pressure sufficient to enable actuators 12, 14 to control the variable geometry device 16. Pressure control device 36, for example, is a valve operated by controller 34 to meter fluid flow through bypass line 32, which controls the fluid pressure within fluid line 26, and in particular, within supply pressure line 28. As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In the exemplary embodiment, controller 34 schedules a desired fluid pressure level in supply pressure line 28 based on load measurement signals from a load feedback device 40 and a load capability device 42.

Load feedback device 40 is coupled to actuator 12 and is in signal communication with controller 34. Load feedback device 40 measures a load placed on actuator 12 by variable geometry device 16 and sends a signal indicative of that measured load to controller 34. In the exemplary embodiment, load feedback device 40 is a differential pressure sensor that measures pressure across piston 22. However, device 40 may be any other suitable type of load measurement device such as, for example, a load cell.

Load capability device 42 is coupled to both supply pressure line 28 and return pressure line 30 and is in signal communication with controller 34. As shown in FIG. 1, load capability device 42 measures the differential pressure across actuator 12 from supply line 28 to return line 30, which provides a measure of the load counteracting capability of fluid 20 that is within supply pressure line 28 at that given time. Although illustrated as measuring the differential pressure across actuator 12, load capability device 42 may alternatively measure the differential pressure across actuator 14 or across both actuators 12, 14. Moreover, more than one load capability device 42 may be coupled to system 10.

In operation, controller 34 operates pressure control device 36 to supply fluid 20 at a desired pressure level to actuators 12, 14. For example, at a steady state condition, controller 34 may supply fluid 20 at a pressure level of 2,000 psig to actuator 12. Actuator 12 may control, for example, a variable area exhaust nozzle of an aircraft jet engine. If the aircraft pilot adjusts the throttle to increase engine thrust, the load on the exhaust nozzle is increased, which also increases the load on actuator 12. Load feedback device 40 measures the increased load on actuator 12 and sends an actuator load signal to controller 34.

Based on the actuator load signal, controller 34 determines that the pressure schedule in supply pressure line 28 must be increased to, for example, a level of 2,500 psig to meet the load demand on actuator 12. This is because actuator 12 now requires a higher counteracting load to maintain sufficient actuator velocity to control the variable area exhaust nozzle providing the higher engine thrust. Based on the fluid line pressure signal from load capability device 42, which in the example indicates a load capability supply 2,000 psig at the steady state condition, controller 34 schedules a fluid pressure level in line 26 that meets or exceeds the actuator load demand of 2,500 psig. As such, controller 34 adjusts pressure control device 36 to provide the desired scheduled pressure to actuator 12 (i.e., increasing from 2,000 psig to 2,500 psig).

System 10 may be operated in a similar manner when load demand on actuator 12 is decreased. For example, load feedback device 40 may measure a decreased load on actuator 12 and send a corresponding actuator load signal to controller 34. Subsequently, controller 34 may determine the pressure schedule should be decreased to, for example, a level of 1,500 psig to actuator 12. Accordingly, based on the actual load signal from device 40 and the fluid line pressure signal from device 42, controller 34 schedules a fluid pressure level in line 26 that meets the actuator load demand.

During operation, it may be desirable to schedule a pressure that exceeds the actuator load demand to assure enough pressure is in system 10 to operate actuators 12, 14 should unforeseen circumstances (e.g., load increases) arise and to account for control tolerances such as pressure scheduling accuracy and feedback error. However, it is also desirable to maintain this pressure schedule overage within a predefined threshold to reduce unnecessary pumping system horsepower expenditure that results in increased heat generation within the system. In one embodiment, the pressure is scheduled to within a range of between approximately 0% and 20% above the actuator load demand. In another embodiment, the pressure is scheduled to within a range of between approximately 0% and 10% above the actuator load demand. In yet another embodiment, the pressure is scheduled to within a range of between approximately 2% and 5% above the actuator load demand.

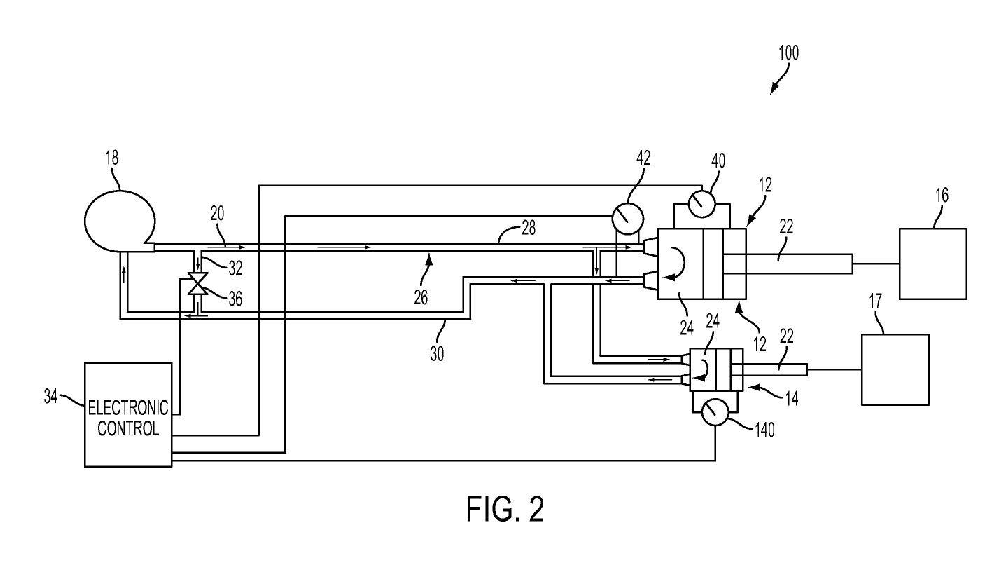

FIG. 2 illustrates a variable pressure actuation system 100 that is similar to system 10 where like references numerals indicate like components. Variable pressure actuation system 100 is similar to system 10 except it includes a second load feedback device 140.

Load feedback device 140 is coupled to actuator 14 and is in signal communication with controller 34. Load feedback device 140 measures a load placed on actuator 14 by a variable geometry device 17 and sends a signal indicative of that measured load to controller 34. In the exemplary embodiment, load feedback device 140 is a differential pressure sensor that measures pressure across piston 22. However, device 140 may be any other suitable type of load measurement device.

In the exemplary embodiment, dual load feedback devices 40, 140 are useful for a situation when the highest load demand may fluctuate between actuator 12 and actuator 14 during operation. System 100 enables controller 34 to determine which actuator 12, 14 requires the highest scheduled pressure and to accordingly schedule that pressure for the system. In this embodiment, controller 34 may include selection logic to determine which measured load of actuators 12, 14 should be used for pressure scheduling. System 10 (FIG. 1), however, may be useful when it is known that actuator 12 is the most load-challenged actuator in system 10 (or is the only actuator in the system).

An exemplary method of scheduling pressure in variable pressure actuation system 10, 100 includes measuring a load placed on actuator 12, 14 with load feedback device 40 and/or 140. An actuator load signal indicative of the measured actuator load is sent to controller 34. The fluid pressure level in fluid line 26 is measured with load capability device 42, and a fluid line pressure signal indicative of the measured fluid line pressure level is sent to controller 34. Based on the actuator load signal and the fluid line pressure signal, controller 34 determines by how much the fluid pressure within supply line 28 must be increased/decreased in order to supply actuator 12, 14 with a pressure level sufficient to operate and counteract the load of variable geometry device 16.

Described herein are systems and methods for scheduling pressure in variable pressure actuation systems. Rather than schedule pressure based on predictive algorithms, the system measures a demand load on an actuator of the system. Based on the actual demand load and a measured fluid pressure level in the supply system, a controller can determine a fluid pressure level to schedule in the system that substantially or closely matches the demand load occurring on that component at the given operating conditions. Accordingly, the system can schedule pressure on-demand and in real time only the amount of fluid that is required to operate the actuator. This prevents having to operate the pumping system at levels higher than necessary, thereby reducing heat generated by the system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A variable pressure actuation system comprising:
an actuator configured to control a variable geometry device;
a fluid line fluidly coupled to the actuator, the fluid line configured to supply a pressurized fluid to the actuator to facilitate controlling the variable geometry device; and
a load feedback device coupled to the actuator, the load feedback device configured to measure a load placed on the actuator by the variable geometry device.

2. The system of claim 1, further comprising a controller in signal communication with the load feedback device, wherein the controller is programmed to schedule a fluid pressure level in the fluid line based on an actuator load signal from the load feedback device.

3. The system of claim 2, further comprising a load capability device coupled to the fluid line, the load capability device configured to determine a fluid pressure level in the fluid line, wherein the controller is further programmed to schedule the fluid pressure level in the fluid line based on a fluid line pressure signal from the load capability device.

4. The system of claim 2, further comprising:
a second actuator configured to control a second variable geometry device; and
a second load feedback device coupled to the second actuator, the second load feedback device configured to measure a load placed on the second actuator by the second variable geometry device, wherein the controller is in signal communication with the second load feedback device and programmed to schedule the fluid pressure level in the fluid line based on the higher measured load between the actuator load signal and a second actuator load signal.

5. The system of claim 2, wherein the fluid line comprises a supply pressure line and a return pressure line, the supply pressure line configured to supply the pressurized fluid to the actuator to control the actuator, and the return pressure line configured to remove the pressurized fluid supplied to the actuator.

6. The system of claim 1, further comprising a pressure control device coupled to the fluid line and in signal communication with the controller, wherein the controller manipulates the pressure control device to schedule the fluid pressure level in the fluid line.

7. The system of claim 1, further comprising a pump fluidly coupled to the fluid line and configured to supply the pressurized fluid to the fluid line.

8. The system of claim 1, wherein the variable geometry device is a variable area exhaust nozzle of an aircraft engine, and wherein the actuator is operatively coupled to the variable area exhaust nozzle.

9. The system of claim 1, wherein the actuator comprises a piston, and wherein the load feedback device measures the differential pressure across the piston to determine the load placed on the actuator by the variable geometry device.

10. The system of claim 3, wherein the load capability device is coupled to a supply line of the fluid line and a return line of the fluid line, wherein the load capability device measures the differential pressure across the actuator from the supply line to the return line to determine the fluid line pressure level available for the actuator.

11. A method of scheduling pressure in a variable pressure actuation system having an actuator configured to control a variable geometry device, a fluid line fluidly coupled to the actuator, and a load feedback device coupled to the actuator, the method comprising:
measuring, with the load feedback device, a load placed on the actuator by the variable geometry device; and
scheduling a fluid pressure level in the fluid line based on the measured load.

12. The method of claim 11, wherein the variable pressure actuation system further comprises a load capability device coupled to the fluid line, further comprising:
measuring, with the load capability device, the differential pressure across the actuator from an upstream supply line of the fluid line to a downstream return line of the fluid line; and
further scheduling the fluid pressure level in the fluid line based on the measured differential pressure across the actuator such that the scheduled fluid pressure substantially matches the measured load on the actuator.

13. The method of claim 12, wherein the variable pressure actuation system further comprises a second actuator configured to control a second variable geometry device, and a second load feedback device coupled to the second actuator, further comprising:
measuring, with the second load feedback device, a load placed on the second actuator by the second variable geometry device; and
wherein said step of scheduling a fluid pressure level in the fluid line based on the measured load comprises scheduling a fluid pressure level in the fluid line based on the higher measured load between the measured load placed on the actuator and the measured load placed on the second actuator.

14. The method of claim 11, wherein said scheduling a fluid pressure level in the fluid line based on the measured load is performed with a controller.

15. The method of claim 11, wherein the actuator comprises a piston, and wherein said step of measuring a load placed on the actuator comprises measuring, with the load feedback device, a differential pressure across the piston to determine a measured load placed on the actuator by the variable geometry device.
